(19) United States
(12) Patent Application Publication
(10) Pub. No.: US 2010/0032437 A1
(43) Pub. Date: Feb. 11, 2010

(54) Container with Transponder

(75) Inventor: Harald Lossau, Munich (DE)

Correspondence Address: GREENLEE WINNER AND SULLIVAN P C, 4875 PEARL EAST CIRCLE, SUITE 200, BOULDER, CO, 80301, US

(73) Assignee: DYNAMIC SYSTEMS GMBH, Wessling (DE)

(21) Appl. No.: 11/721,931

(22) PCT Filed: Dec. 15, 2005
(86) PCT No.: PCT/EP2005/013478

§ 371 Date: Aug. 26, 2009

(30) Foreign Application Priority Data
Dec. 17, 2004 (DE) 10 2004 061 633.7

(51) Int. Cl. B65D 90/00; G06K 7/01; G06K 19/077

(52) U.S. Cl. 220/694; 340/10.42; 340/10.41; 235/492

(57) ABSTRACT

In a container (1) for transporting and storing substances that is provided with a transponder for radio frequency identification, it is provided that the container exhibits a substantially cylinder-shaped main section (12) having a curved lateral surface, and that the transponder includes an electronic memory (21) and, as a coupling element, an antenna coil (22), the antenna coil (22) being disposed in or on a wall surface of the container (1) and with its axis parallel to the cylinder axis of the main section (12). According to the present invention, the antenna coil (22) is disposed in the region of the cylinder-shaped main section (12) of the container on the lateral surface of the cylinder and exhibits one or more windings around the cylinder axis.

### FIELD OF THE INVENTION

The present invention relates to a container for transporting and storing substances that is provided with a transponder for radio frequency identification. The present invention further relates to a semifinished transponder product, a manufacturing method for a container furnished with a transponder, and a method for automatically marking, identifying and tracking a substance.

### BACKGROUND OF THE INVENTION

Transponder technology has been used successfully for years in many applications: Typical examples are the contactless company ID that enables entrance to the workplace, and the immobilizer system based on a transponder built into the vehicle key. In Germany, invoices for waste removal have likewise already been being generated for years with the aid of transponders in household trash cans. Here, every time the trash can is emptied, the unique code is automatically read by the vehicle and the waste quantity is attributed to the trash can owner [RFID-Forum, Magazin für kontaktlosen Datentransfer April 2004, Every Card Verlags GmbH Lüneburg, p. 33]. Here, the transponder, or RFID, technology proves to be more robust than conventional marking systems, especially labels having barcodes: Despite a growing number of built-in redundancies, the chances of detecting dirty, covered or damaged barcodes are poor. RFID technology, on the other hand, which is not dependent on an optical line of sight, offers a constant high reading quality also with heavily soiled data carriers.

Further advantages of RFID technology are the principally high memory capacities (currently up to 64 kBytes) and the possibility of reprogramming and encrypted data transmission.

A transponder commonly consists of a coupling element (coil or microwave antenna) and an electronic microchip. Outside the response range of a reading device, the transponder, which normally exhibits no independent voltage supply (battery), is typically completely passive. Only inside the response range of a reading device is the transponder activated. The energy needed to operate the transponder is transmitted to the transponder contactlessly by the coupling unit, as are timing and data.

The mutual inductance M governing the energy supply and data transmission of the transponder is proportional to the cross-sectional area A and number of windings n of the transponder coil, and to the cosine of the angle θ between the magnetic field lines of the reading device and the central axis of the coil: M˜n·A cos θ. A high mutual inductance permits a high readout range of the transponder and/or an energy supply in complex transponder chips, for example having large memory capacity or having a complex processor for carrying out anticollision procedures or encrypted data transmission.

The following transponder designs are known:
B1: Disks: The so-called disks or coins are the most frequent design, transponders having a round injection-molded housing having diameters of a few millimeters up to 10 cm. Is required for a good energy supply of the transponder. The smallest disk transponder (clothing tag) on the market in the 13.56 MHz frequency band has a diameter of 16 mm, but it has a memory capacity of just 120 bytes [RFID-Forum June 2004, p. 10].
B2: Glass housing: For identifying animals, glass transponders were developed that can be injected under the skin of the animal. A microchip mounted on a substrate and a chip capacitor are located in a glass tube just 12 to 32 mm long having an outer diameter of approx. 4 mm. The transponder coil is wound from just 0.03 mm thick wire on a ferrite core. For mechanical stability, the internal components are embedded in a soft adhesive.
B3: Plastic housing: The plastic housing was developed for applications with particularly high mechanical requirements. This housing is also popularly integrated in other designs, such as in car keys for electronic immobilizer systems. The tapered cube consisting of molding compound (IC sealing compound) and having the dimensions 12×5.9×3 mm³ includes nearly the same components as the glass transponder, but has a greater functional range due to the longer coil.
B4: Chip cards: The ID-1 design known from credit and telephone cards (85.72×54.03×0.76 mm³) is becoming increasingly important also in RFID systems as a contactless chip card. The advantage of this design for inductively coupled RFID systems consists in the large coil area, resulting in high ranges in the chip cards.
   Contactless chip cards are created by laminating a transponder between four PVC foils. Here, the individual foils are baked at high pressure and temperatures over 100° C. into an inseparable unit.
   However, the maximum thickness of 0.8 mm required for ID-1 cards need not always be maintained. Primarily microwave transponders require thicker designs.
B5: Smart labels: A smart label is understood to be a paper-thin transponder design. Here, the transponder coil is applied by screen printing or etching technique to a 0.1 mm thick plastic foil. This foil is frequently laminated with a paper layer and coated on the reverse with an adhesive. The transponders are supplied as self-adhesive labels and can be affixed directly.
B6: Coil-on-Chip: In the designs introduced so far, the transponders are manufactured from a separate transponder coil that functions as an antenna, and a transponder chip (hybrid technology). By way of miniaturization, it is obvious to also integrate the coils on the chip (Coil-on-Chip). Here, the coil is placed immediately on the insulator of the silicon chip as a planar (single-layer) spiral arrangement and contacted with the underlying circuit through conventional openings in the passivation layer. The size of the chip and thus of the entire transponder is just 3×3 mm². For improved handling, the transponders are frequently also embedded in a plastic body and, with φ6 mm×1.5 mm, are among the smallest RFID transponders available on the market.

By combining a transponder with a sensor, it is possible to wirelessly transmit, in addition to an identification number, physical measurement data [RFID-Forum June 2004, p. 20]. Here, usually active transponders are used, i.e. having an integrated battery, for independently capturing measurement data outside the range of the reading station. Applications are especially in temperature monitoring when transporting sensitive goods, such as blood supplies, plants and fresh meat.

Marked containers are often used for marking and ensuring the traceability of goods and the documentation of process steps in the flow of goods—whether steps in production, analysis, quality assurance, transportation, delivery of goods, consumption or disposal. If transponders are to be used for this, an array of practical problems arises with regard to the optimum attachment to or integration in the container. This issue is particularly pronounced in small, thin-walled containers, especially if they exhibit curved surfaces.

Furthermore, ensuring a suitable orientation of the transponder coil relative to the magnetic field of the readout device in the readout process often poses a problem, since a sufficient interaction strength between readout device and transponder is achieved only with a suitable relative orientation. Also, containers that are touching each other or standing close together make the interference-free readout of the data stored on the appropriate transponders difficult or even impossible.

In DE 4313049 is described a cuboidal transport container having a transponder that is placed in an edging rail at a side wall. Here, a pin-shaped transponder of design B2 or B3 is used that can be inserted into the edging rail. The document is limited to containers having a right-angled base area and vertical side walls. The mentioned problems of marking small, thin-walled containers and containers having curved surfaces, and ensuring the correct orientation are not solved in this application.

Utility model DE 9407696 U1 describes a plastic container that includes a transponder in the container wall or in a thickened portion of the container wall. The transponder is protected in that it either is fixed in a slit introduced into the container wall in injection molding or is poured directly into in the wall. Here, the transponder is affixed parallel to the surface. Thin-walled, small containers or containers having curved surfaces are thus not included. Also missing are statements regarding ensuring a correct orientation of the containers.

In publication WO 01/029761 is described a container tracking system and a reusable container having a transponder. Here, data concerning the staging point of the container, conditions or other data of the transported articles and data for obtaining a user profile of the container can be received by and retrieved from the transponder. The description of the container itself is limited to a folding box with rectangular base measurements starting at 40×30 cm², especially for transporting foodstuffs.

From DE 103 10 238 is known a container comprised of plastic having an integrated transponder that is manufactured by injection molding, the transponder lying in a plastic casing, together with which it is injected as an insert into the plastic material of the container when it is manufactured. The advantages here are the integration of the transponder in the injection-molded container, the relatively thin embodiment of the insert compared with its area, and the economical manufacture. What is not solved here, however, is the integration of the transponder in containers having curved surfaces, the ensuring of the correct orientation of the transponder coil relative to the magnetic field of the readout device in the readout process, or the ensuring of as large a spacing as possible of the transponders of two containers touching each other or standing close together. Furthermore, in practice, the integration of such an areal insert in small vessels, such as sample tubes, is difficult.

Publication DE 299 10 452 U1, which relates to an apparatus and a test bottle for checking the operability of bottle inspection machines, discloses a test bottle having a transponder whose ring-shaped antenna is wound in the region of the ring groove between the reinforced rim and the head of the test bottle. Here, the antenna coil is oriented concentrically to the central bottle axis to achieve a reliable retrieval of the code also for a transceiver unit having an antenna stationarily disposed at a small distance above the movement path of the transported test bottles. However, the range of such an arrangement is very limited, so that the transceiver antenna must be disposed in the immediate vicinity of the antenna coil of the test bottles.

### DESCRIPTION OF THE INVENTION

This is where the present invention begins. The object of the present invention, as characterized in the claims, is to avoid the disadvantages of the background art and especially to specify a generic container that allows a secure and interference-free readout of the included transponder, also in designs that are small and provided with curved surfaces, also at some distance.

According to the present invention, this object is solved by a container having the features of the independent claims. A semifinished transponder product, a manufacturing method for a container furnished with a transponder and a method for automatically marking, identifying and tracking a substance are specified in the coordinated claims. Further advantageous details, aspects and embodiments of the present invention are evident from the dependent claims, the description, the drawings and the examples.

The following abbreviations and terms will be used in the context of the present invention:

The abbreviation RFID (radio frequency identification) is used here generally for identification systems with contactless electromagnetic energy and data transmission—independently of the carrier frequency used.

A transponder readout device is understood to be a system that supplies a transponder with energy through electromagnetic fields, reads data from its chip and, optionally, can also write data to the chip.

According to a first aspect of the present invention, a container of the kind cited above exhibits a substantially cylinder-shaped main section having a curved lateral surface. Furthermore, the transponder includes an electronic memory and, as a coupling element, an antenna coil that is disposed in or on a wall surface of the container and with its axis parallel to the cylinder axis of the main section. According to the present invention, the antenna coil is disposed in the region of the cylinder-shaped main section of the container on the lateral surface of the cylinder and exhibits one or more windings around the cylinder axis.

By applying the transponder coil in the region of the lateral surface, the coil area corresponds to the cross-sectional area of the container and is thus maximally large for the given orientation. Consequently, also the energy transmission and range associated with the mutual inductance M is optimized for the given container cross-sectional area.

Through these measures it can be ensured that, in the readout process, the antenna coil of the container is arranged in a correct orientation relative to the magnetic field of the readout device. Furthermore, as large a minimum spacing as possible of the response regions of the transponders of two containers touching each other or standing close together is ensured and an unambiguous and interference-free readout is thus facilitated.

The characteristic trait of all embodiments is the fact that the container exhibits a substantially cylinder-shaped main section having a curved lateral surface. The main section is of substantial importance for the container either in terms of its size or its function. The cylinder-shaped main section can constitute, for example, a receiving region that receives the substances to be transported or stored.

In another embodiment, the cylinder-shaped main section constitutes a handling region that serves the handling, such as the transport or storage, of the container. In the latter case, the main section is preferably connected with a conically tapering receiving region that receives the substances to be transported or stored. In other embodiments, the cylinder-shaped main section takes up more than 50%, especially more than 70% of the dimension of the container in the direction of the cylinder axis and thus dominates the design of the container.

The term “substantially cylinder shaped” comprises especially circular-cylindrical forms, but also cylindrical forms in which the actual or—in the event the main section passes over into another region—imagined base and lid surfaces consist of at least pentagonal polygons having rounded angles, circular or elliptical arcs or other smooth curved sections. Here, the individual sections pass over each other without sharp bends.

In advantageous embodiments, the container itself is substantially cylinder shaped, it being understood that, in secondary sub-regions, deviations from the cylinder shape can occur, especially in the region of the base or lid, for example due to tapering toward the lid (bottles, for example) or toward the base (Eppendorf tube according to DE 196 45 892, for example) and due to the attachment of mounts, windings or screw closures. Here, small deviations from the cylinder form, also in the cylindrical main section, for example due to a waist, are without importance for the application described here.

According to another aspect of the present invention, a container of the kind cited above exhibits a substantially cylinder-shaped main section having a curved lateral surface. Furthermore, the transponder includes an electronic memory and, as a coupling element, an antenna coil that is disposed in or on a wall surface of the container and with its axis parallel to the cylinder axis of the main section. According to the present invention, the cylinder-shaped main section is connected with a conically tapering receiving region that receives the substances to be transported or stored. Also in this aspect of the present invention, the above-described embodiments of the antenna coil are advantageously used.

According to a further aspect of the present invention, a container of the kind cited above exhibits a substantially cylinder-shaped main section having a curved lateral surface. Furthermore, the transponder includes an electronic memory and, as a coupling element, a dipole antenna that is disposed in the region of the cylinder-shaped main section of the container in or on the lateral surface of the cylinder. The dipole antenna is either disposed linearly and with its longitudinal axis parallel to the cylinder axis of the main section, or it is wound around the cylinder-shaped main section of the container as an open coil with the coil axis parallel to the cylinder axis of the main section.

Embodiments having a dipole antenna are particularly suitable for operation in the ultra high frequency range (UHF)—especially for passive UHF transponders in the frequency range 865-950 MHz—and achieve a particularly high read range.

If the dipole antennas of containers set up in parallel are each disposed linearly and parallel to the cylinder axis, then a uniformly oriented arrangement of the antennas results such that they can be read out with a parallel-oriented antenna of a reading device reliably and still at a great distance. On a conveyance path transverse to the bottle axis, a defined selective readout of the transponder positioned in the main beam direction in each case is thus also possible. The preference of a more distant transponder (false read) due to different orientations is thus excluded.

In a likewise preferred embodiment, the dipole antenna is wound around the cylinder-shaped main section of the container as an open coil with such a pitch that the dipole antenna extends substantially across the entire dimension of the main section parallel to the cylinder axis. In this way, for the given size of the cylinder-shaped main section, a maximum coupling of the dipole antenna to the electromagnetic field of the readout device is achieved. Even for a very narrow main section, the pitch of the open coil is advantageously chosen to be, in any case, even larger than the width of the circuit path of the antenna.

Advantageously, in all aspects of the present invention, at least the cylinder-shaped main section or even the entire container with the exception of closures, mounts or windings exhibits no edges. In this way, it is ensured that the application of the chip and the antenna coil to the main section or container is not impeded by edges. On the other hand, curves—especially having a small radius of curvature—interfere with the application and readout of conventional barcode labels or smart labels.

The container expediently consists of a plastic material such as PE, PP, PS, PET, ABS, an epoxide resin, a molding compound or IC sealing compound, or of glass. In an advantageous embodiment, the transponder is embedded in plastic, glass or a lacquer layer beneath the surface of the container. The container is preferably formed to be resistant to liquids, chemicals, mechanical stresses, especially abrasion, or sterilization or autoclaving processes.

The transponder is advantageously designed for a low-frequency operating frequency and inductive coupling, since material dependencies of typical substances to be transported or stored are of no import in this frequency range. Preferably, the transponder is designed for an operating frequency between 9 kHz and 135 kHz, preferably between 100 kHz and 135 kHz. However, the transponder can also be designed for an operating frequency in the ISM frequency range, especially for an operating frequency around 6.78 MHz, 13.56 MHz, 27.125 MHz, 40.68 MHz, 433.92 MHz, 869.0 MHz, 915.0 MHz, 2.45 GHz, 5.8 GHz or 24.125 GHz. Here, the frequency range around 13.56 MHz with likewise inductive coupling constitutes a particularly preferred compromise since, compared with higher frequencies, material dependencies are still within limits, but at the same time, fast data transmission is possible compared with the low-frequency range. Furthermore, this frequency range is currently developing into a standard for transponders worldwide.

The container is expediently closable with an associated lid, especially with a seal lid or screw top.

In a variant of the present invention, the transponder is disposed in the base or lid of the container. In particular, the transponder can be attached in a sealed disk at the base or lid of the container and be attached at the base or lid by gluing, by melting when manufacturing the container, or as an insert in injection molding.

The container can be a (returnable) bottle, a recycling container or a cup manufactured in the deep drawing method. In other embodiments, the container constitutes a reaction vessel, such as a sample tube, an Eppendorf tube or a Petri dish, especially for clinical and biochemical labs, or a sample vessel within a microtiter plate.

The electronic memory of the transponder includes preferably data, such as an identification code, specification of the contents, origin of the contents, patient data for clinical applications, processing steps performed or to be performed, processing stations passed through or to be passed through, staging points and times, physical measurands, such as temperature, pressure, fill level and acceleration, that stem especially from a sensor integrated into the transponder, manufacturing date of the contents and/or of the container, and operating manual or control code for processing systems.

The electronic memory can be formed as read-only memory or as rewritable memory.

The container can further comprise a rotation limiter that, on a conveyance path, prevents the rotation of the container about its own axis. In this way, a uniform orientation of a plurality of containers can be ensured.

In other embodiments, the container advantageously comprises a spacer that ensures a preselected minimum spacing of adjacent containers on a conveyance path.

The present invention further includes a semifinished transponder product having a transponder component and a thin, flexible substrate having at least two open circuit paths connected with the transponder component. Here, the circuit paths are disposed on the substrate such that, when the substrate is applied to a substantially cylinder-shaped container, they come into contact with each other to form a closed antenna as the coupling element of the transponder component.

In a preferred variant, the substrate is electrically insulating. In this case, the circuit paths on one of two opposing sides protrude over the substrate and, when the substrate is applied, the protruding circuit path portions come into contact with the circuit paths on the other of the two opposing sides to form a closed antenna.

According to an alternative embodiment, the semifinished transponder product includes a transponder component and a thin, flexible substrate having a dipole antenna connected with the transponder component, in which the dipole antenna is disposed on the substrate such that, when the substrate is applied to a substantially cylinder-shaped container, it forms an open coil that is wound around the container with a coil axis parallel to the cylinder axis of the container.

In both embodiment types, the substrate is formed for easy application, preferably self-adhesively. Further, the substrate preferably consists of a plastic foil, while the circuit paths or the dipole antenna expediently consist of metal foil or a conductive paste applied by screen printing.

To compensate for differences in the antenna cross section when the substrate is applied to different-sized containers, and thus enable the use of a semifinished product for different-sized containers, the transponder component advantageously includes a circuit for frequency stabilization.

Furthermore, the transponder component and/or the circuit paths or the dipole antenna are expediently provided with an insulating layer or protective layer.

The present invention also includes, for fixation to or in a transport or storage container, a sealed transponder that includes an electronic memory and, as a coupling element, an antenna coil, and that is embedded in a sealing compound.

The present invention further provides a method for manufacturing a container of the kind described above, in which the antenna coil of the transponder is disposed in or on a wall surface of the container and with its axis parallel to the cylinder axis of the main section.

In a first advantageous variant of the method, a coil wire is wound around the cylinder axis on the lateral surface of the cylinder-shaped main section to form the antenna coil of the transponder. A transponder component is then expediently applied, especially affixed and electrically connected with the previously formed antenna coil by welding or bonding. Preferably, the entire transponder is also provided with a protective layer. This can be formed by an applied lacquer or plastic layer or an appropriately comprehensive protective body.

In another advantageous variant of the present invention, the transponder is formed on or in a plastic surface that is suitable for deep drawing and formed therefrom by deep drawing at least the cylindrical main section, the base or the lid of the container. Here, the transponder is preferably formed in a stacked layer sequence. Here, the layers of the layer sequence are advantageously brought into a soft elastic state and baked together before, during or after deep drawing. If this lamination process takes place after deep drawing, then the transponder can be manufactured before or after deep drawing. In some embodiments, it can be appropriate to laminate only the lid and/or base surface of the container.

In a further advantageous variant of the present invention, the transponder is embedded in a sealing compound and the sealed transponder fixed to or in a base or lid surface of the container, especially glued or poured in. For this, the base surface can exhibit a bulge or hollow in which the sealed transponder is fit. The transponder can also be assembled on a substrate without housing and be poured into a base or lid surface of the container.

According to yet a further, likewise advantageous variant of the present invention, the transponder is introduced into a self-adhesive label and the label affixed on a base or lid surface of the container.

The present invention also includes a method for automatically marking, identifying and tracking a substance, having the following method steps:
Providing a container having a transponder of the kind described above,
Providing for the transponder one or more readout devices that are disposed at locations at which an identification or processing of the substance is to take place,
Writing an unambiguous identification code to the electronic memory of the transponder,
Filling the substance into the container, and
Reading out the identification code when the container is located at one of the readout devices.

According to an advantageous variant of the method, information about the filled substance or the substance to be filled is written to the electronic memory. This can occur, for example, when the identification code is being written to it. If desired, a time code, location code and/or data regarding the substance processing can be written to the electronic memory when the container is located at one of the readout devices. Advantageously, when writing to and/or reading out the electronic memory, a secure data transmission is carried out, especially through identification or authorization protocols. The data communication can also be carried out encrypted.

Preferably, in the method, a plurality of homogeneous containers is marked and filled with substances, and all containers are directed past the readout device(s) with the same orientation of their cylinder axis.

Overall, through the present invention, the following advantages are realized:
Protection of the transponder against (mechanical and chemical) damage when handling the container or by the goods transported in the container, especially also by liquids and chemical substances;
Integration of the transponder in thin-walled or small vessels;
Integration or attachment of the transponder to containers having curved surfaces;
Ensuring a sufficient energy supply and range;
Ensuring of the correct orientation of the transponder coil relative to the magnetic field of the readout device in the readout process;
Ensuring of as large a minimum spacing as possible of the response regions of the transponders of two containers touching each other or standing close together to facilitate an unambiguous interference-free readout; and
Economical manufacture of the system.

The invention will be explained in greater detail below by reference to exemplary embodiments in association with the drawings. Only the elements that are essential to understanding the present invention are depicted. Shown are:

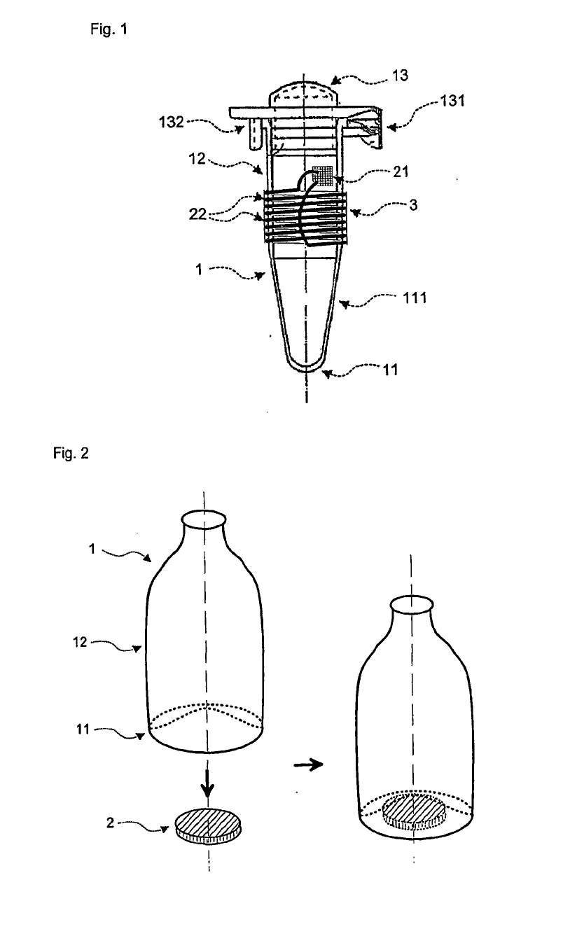

FIG. 1A reaction vessel having a transponder that is subsequently assembled on the external lateral surface;

FIG. 2 A vial having a transponder in disk design introduced into the base;

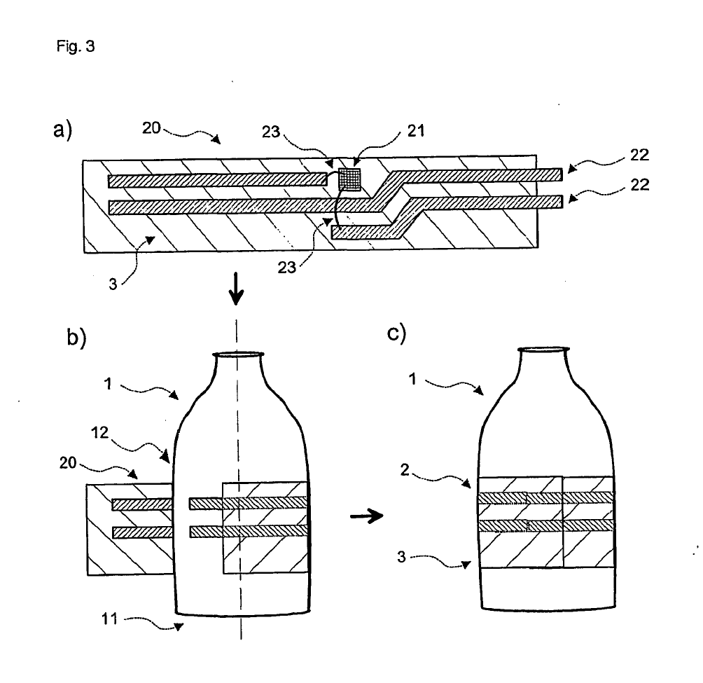

FIG. 3 The manufacture of an RFID bottle with the aid of a self-adhesive semifinished transponder product: a) self-adhesive semifinished transponder product having an open coil, b) affixing the semifinished transponder product to the bottle, c) finished RFID bottle;

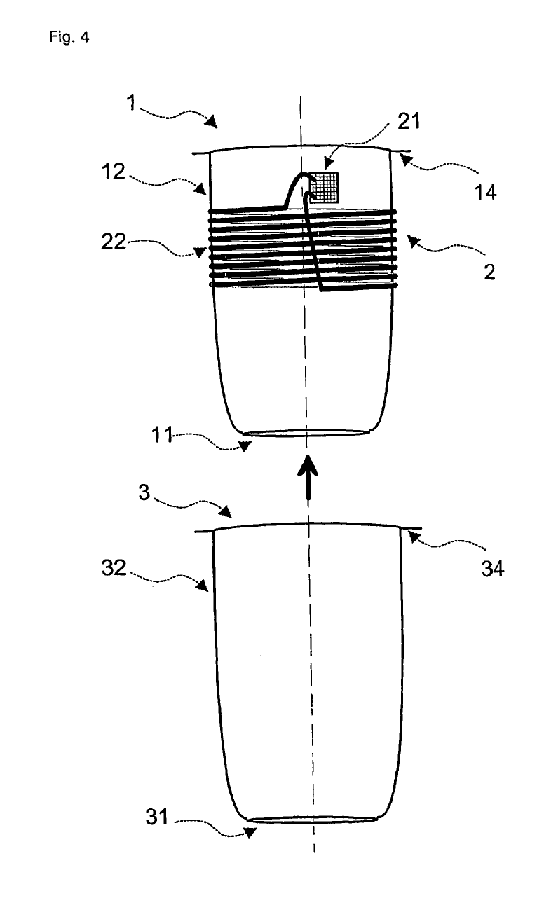

FIG. 4 an RFID cup consisting of two nested cups, the transponder being assembled on the external lateral surface of the inner cup;

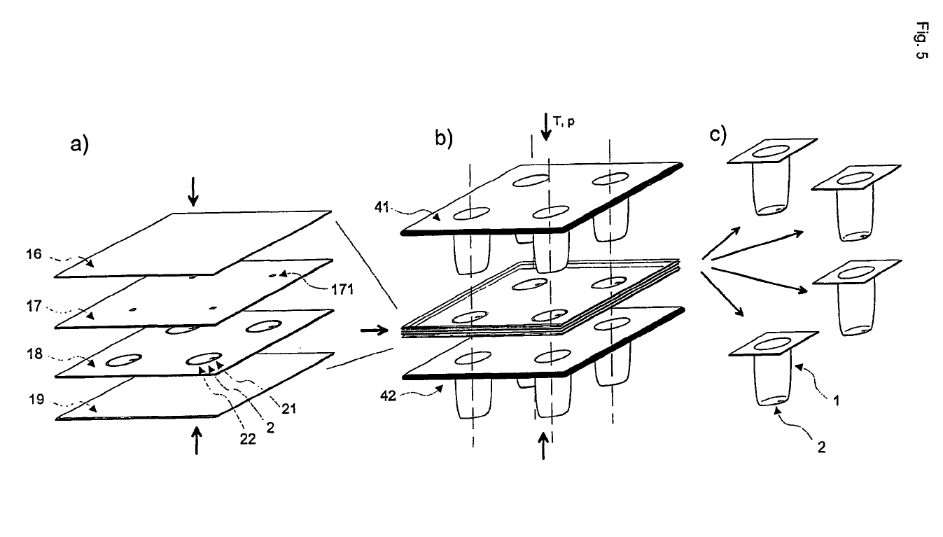

FIG. 5 the manufacture of an RFID cup in a deep drawing process: a) assembly of the transponder with planar substrate foils, b) laminating and deep drawing;

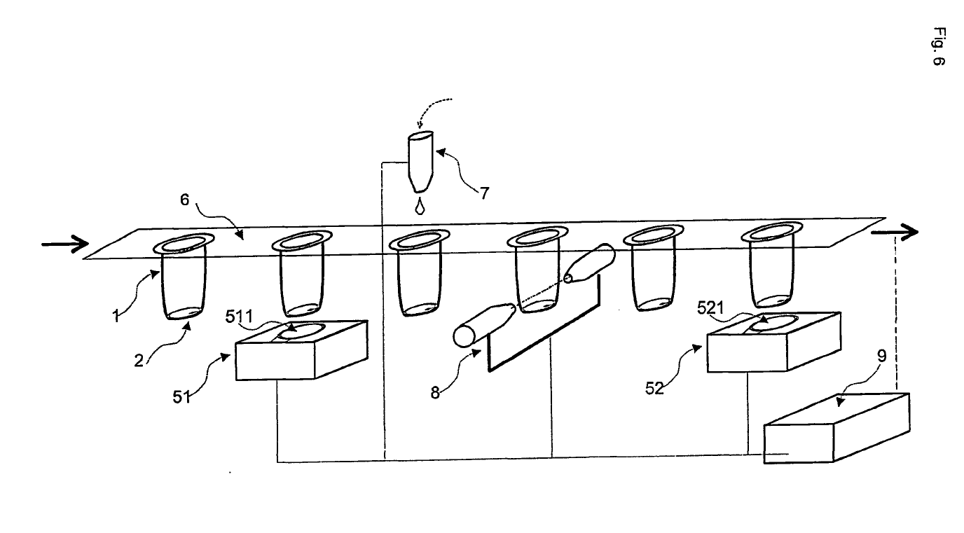

FIG. 6 the use of RFID sample tubes in an automatic synthesis or analysis station;

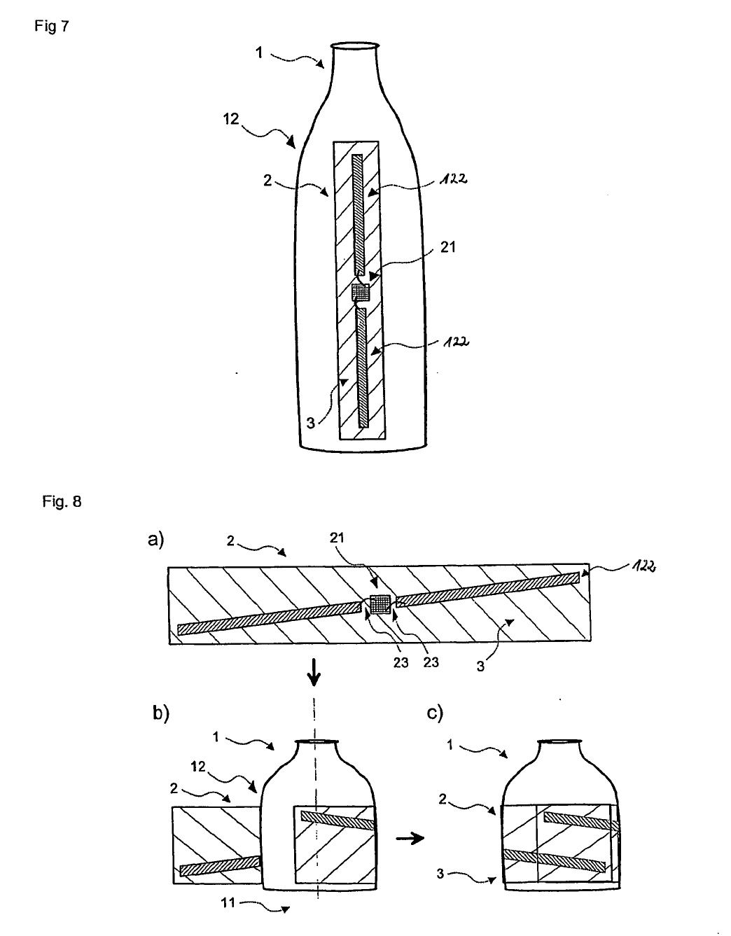

FIG. 7 An RFID bottle having a dipole antenna for operation in the ultra high frequency range according to a further exemplary embodiment of the present invention; and

FIG. 8 the manufacture of an RFID bottle having a dipole antenna formed as an open coil: a) self-adhesive substrate having a transponder and dipole antenna, b) affixing the substrate to the bottle, c) finished RFID bottle.

### MANNER OF EXECUTING THE INVENTION

First is explained with reference to FIG. 1, as an exemplary embodiment, a sample tube, such as a so-called Eppendorf tube, having a transponder that is subsequently assembled on the external lateral surface.

In FIG. 1, reference number 1 denotes the reaction vessel composed of plastic (having base 11, cylinder-shaped main section 12 and lid 13), reference number 21 the transponder chip, 22 the transponder coil, and 3 a protective layer composed of plastic. As the reaction vessel, in this exemplary embodiment, a commercially available Eppendorf tube is assumed, as described for example in DE 196 45 892.

This vessel comprises, in addition to a relevant inventive cylinder-shaped main section 12 that serves the handling of the reaction vessel, a base 11 having taperings in the base region 111, a lid 13 having a lid mount 131 (hinge) and latch 132.

The coil wire of the transponder coil 22 is wound onto the lateral surface of the cylinder-shaped section 12 of the vessel with an automatic winder. Preferably, the copper wires used are provided with, in addition to the usual insulating varnish, an additional layer of low-melting baking varnish. During the winding process, the vessel is heated to the melting temperature of the baking varnish. This melts during the winding process, causing the individual windings of the transponder coil to stick together. In this way, the mechanical stability of the coil is already ensured prior to the protective layer to be applied at the end of the production process. Following the winding of the coil, there are two variants to choose from for contacting the transponder chip 21: If the mechanical stability requirements and the size of the reaction vessel permit the use of very thin coil wires (<=50 μm), then the wire can be bonded directly to the transponder chip. Alternatively, a transponder module (transponder chip that is fixed on a substrate or in a housing) is used. The connectors of the coil are welded to the terminal areas of the transponder module with a spot welder. Finally, the entire transponder assembly is coated with a protective layer 3 composed of plastic. Here, the protective layer is applied either still on the winder by pouring or spraying, or by immersing the vessel in liquefied plastic.

In further embodiments of a sample tube having a transponder, the antenna coil is not wound from wire, but rather either
with the aid of a mask, etched out of an areal conductive coating—preferably a copper coating—of the external wall of the sample tube,
manufactured from a conductive polymer, preferably a silver conductive adhesive with epoxide resin, that is applied to a rotating sample tube or
is manufactured from a conductive paste (known as polymer thick film—PTF) that is imprinted on the lateral surface.

FIG. 2 shows a bottle 1 having a cylinder-shaped main section 12 and a base 11 that is curved inward or provided with a hollow and into whose bulge or hollow a finished sealed transponder 2 in disk design is introduced. The fixation of the sealed transponder 2 at the base occurs either by gluing it into the hollow of the prefabricated bottle or directly in the bottle production process in that the transponder is fused with the base as an insert in injection molding or in blowing the bottle. In the second case, to obtain a good connection between transponder housing and bottle, both are preferably manufactured from the same material—for example polystyrene (PS), polyethylene terephthalate (PET) or polypropylene (PP).

The transponder in disk design includes, in addition to the transponder chip, a circular antenna that runs near the lateral surface inside the disk-shaped injection-molded housing. Due to the coaxial arrangement of the disk transponder and the cylinder-shaped bottle, the following inventive advantages are ensured: uniform orientation of the transponder coils in bottles standing in parallel, ensuring a minimum spacing (=bottle diameter) of the coil axes, a large coil area relative to the vessel, and thus a high energy transmission and range. Further advantages of this arrangement are the protected position and thus stable fixation of the transponder in the hollow of the base, the possibility to attach a transponder to thin-walled and small vessels and vessels having small radii of curvature.

A further embodiment with comparable advantages is a Petri dish (a shallow, cylinder-shaped vessel) on whose base or lid a smart label, i.e. a self-adhesive transponder label, is affixed from outside in such a way that the transponder coil runs around the cylinder axis. Here, a circular smart label is preferably affixed concentrically such that the cylinder axis passes through the area of the transponder coil.

FIG. 3 shows the manufacture of an RFID bottle with the aid of a self-adhesive semifinished transponder product. The self-adhesive semifinished transponder product 20 (FIG. 3a) is assembled on a self-adhesive foil 3 and comprises the transponder chip 21, circuit paths 22 for assembling the transponder coil and two bonding wires 23 for connecting the two outer circuit paths with the chip 21. The circuit paths 22 are disposed such that their open ends are contacted with each other when the semifinished transponder product is glued to a cylinder-shaped object having a specified perimeter. To ensure a reliable contact, a conductive adhesive (silver conductive adhesive) is applied to the contact sites prior to gluing together.

In FIG. 3b is depicted how the semifinished transponder product 20 is affixed to the cylinder-shaped section 12 of a bottle 1. In a completely affixed semifinished transponder product (FIG. 3c), the circuit paths form a closed coil that, together with the contacted chip, results in a functional transponder 2. Here, the foil 3 forms a through protective layer for the transponder. Here, it can simultaneously serve as a printable label for the bottle.

FIG. 4 shows the manufacture of an RFID cup from two nested cups. Both cups are preferably manufactured in the deep drawing method from a thin plastic plate—for example from polypropylene (PP). (However, more complex forms, such as cups with a screw top, can also be manufactured in the injection molding method.) They are dimensioned such that the inner cup 1 can be nested exactly in the outer cup 3 and welded with it. Both cups comprise a substantially cylinder-shaped section 12 and 32 that, however, is embodied minimally conically to facilitate the nesting of the cups. The cup wall in the cylinder-shaped section 12 and 32 is thin and flexible enough to be able, when nesting, not only to compensate for manufacturing tolerances, but also to still be able to receive the transponder 2 that is mounted on the lateral surface of the inner cup.

Similar to what is described with reference to FIG. 1, the transponder 2 consisting of chip 21 and coil 22 is assembled on the cylinder-shaped section 12 of the inner cup 1.

Thereafter, the cups are nested and welded together. Depending on stability requirements, the welding is done across the entire surface or only in the area of the lid flange (14 and 34) and, if needed, in the base region (11 and 31).

In the following, the manufacture of an RFID cup in the deep drawing method is explained with reference to FIG. 5. The starting point is the assembly of a transponder with planar plastic foils, as is common in the manufacture of transponder chip cards (FIG. 5a). The manufacture of transponder chip cards is described in Finkenzeller Klaus, RFID Handbuch, Carl Hanser Verlag, Munchen 2002, pages 344 to 351, which section is incorporated in the present description. It can occur in 4 ways: i) winding technique (conventional winding of the coil and subsequent deposit on the foil), ii) laying technique (laying the wire with a sonotrode directly on the foil), iii) screen printing technique (printing a conductive polymer thick-film paste on the foil in the screen printing method) and iv) etching technique (extracting the coil from a contiguous copper foil laminated onto the foil and coated with exposed photoresist).

A chip card is typically assembled from four foils: Two inlet foils, including one substrate foil 18 on which the transponder 2 is assembled, and an intermediate foil 17 diecut in the region 171 of the chip 21, as well as two overlay foils 16, 19 that form the outside of the card. While the stiffest plastics possible are used for manufacturing chip cards, easily thermally formable plastics that are suitable for deep drawing are preferred for manufacturing RFID cups according to the present invention. Here, it is appropriate to use plastics such as polyethylene (PE), polyethylene terephthalate (PET), polyvinyl chloride (PVC), polystyrene (PS) and especially polypropylene (PP).

After the transponder is assembled and the foils are laid over each other in perfect register, the foils are laminated, i.e. brought into a soft elastic state and baked together at an elevated temperature (T=approx. 100-200° C.) and high pressure (p=20-120 kg/cm²). Thereafter, in the deep drawing method, the baked foils are jointly formed into the cup according to the present invention (FIG. 5b). To the extent that, in deep drawing, the deformation of the foils in the region of the transponder is minor, the lamination process and the deep drawing can also be carried out in a joint step in that the four foils are formed with two forms 41 and 42 that fit into each other, and baked together. The transponder is thus preferably located in the base of the substantially cylinder-shaped cup, the transponder coil running around the cylinder axis parallel to the edge of the base.

Following lamination, deep drawing and cooling, the individual formed RFID cups 1 are diecut from the multiple-up sheet (FIG. 5c).

In a variant of the RFID cup described here, only the base composed of the four foils that contain the transponder is laminated. The rest of the cup then consists only of one foil, which is brought into form through deep drawing.

FIG. 6 shows, by way of example, the use of RFID sample tubes in an automatic processing station that can be used to synthesize and analyze chemical, biological or medicinal substances. The sample tubes 1, which are each provided with a transponder 2, come from a storage container or from upstream processing units and are directed on a linear transport apparatus 6 past a first transponder readout device 51, a processing unit 7 and an analysis unit 8 and, optionally, past a further transponder readout device 52. Thereafter, the tubes are transported further past an output storage container or further processing units.

The antennas of the transponder readout devices 511 and 521 are disposed near one hold point each of the transponders 2 such that their magnetic field lines at the appropriate hold point run parallel to the coil axis of a transponder present there, and a selective readout of this transponder is made possible.

Through the arrangement of multiple processing stations in series, possibly supplemented by (tempered) intermediate storage and sorting units, complex syntheses and analyses can be carried out. The entire processing system is controlled via a central data processing unit 9.

The following data can be stored on the transponder 2 of each sample tube 1: identification number of the sample tube, specification of the contents, origin of the contents, patient data for clinical applications, processing steps performed or to be performed, processing stations passed through or to be passed through, staging points and times, physical measurands, such as temperature, pressure, fill level and acceleration, especially from a sensor integrated into the transponder, manufacturing date of the contents and/or of the container, and operating manual or control code for the processing unit.

The information serves especially the unambiguous marking of the substances in the sample tube, the control and documentation of the production or analysis steps, and thus the traceability and quality assurance of the processes.

In FIGS. 7 and 8, exemplary embodiments of containers according to the present invention are shown in which the antenna of the transponder 2 is embodied as a dipole antenna 122. These embodiments are suitable especially for operation in the ultra high frequency range (UHF)—especially for the passive UHF transponder in the frequency range 865-950 MHz. The disadvantage of a stronger material dependency of the operability of transponders in this frequency range is countered by the advantage of the principally higher read range.

FIG. 7 shows a bottle 1 having a cylinder-shaped main section 12 on whose lateral surface a transponder 2 having a transponder chip 21 and a dipole antenna 122 is applied on a flexible substrate 3. Here, the dipole antenna 122 is applied parallel to the cylinder axis of the main section 12.

According to the present invention, the advantage of this arrangement consists in that, in bottles disposed (set up) in parallel, the respective antennas are oriented with a uniform orientation and thus preferably can be read out with a uniform, parallel orientation of the antenna of the reading device. On a conveyance path transverse to the bottle axis, a defined selective readout of the transponder positioned in the main beam direction in each case is thus also possible. The preference of a more distant transponder (false read) due to different orientations is thus excluded.

Here, the container 1 and/or the conveyance path preferably comprises a means that prevents a rotation of the container about its own axis.

Alternatively or additionally, the container and/or the conveyance path can comprise a means that ensures a minimum spacing of the lateral surfaces of adjacent bottles.

FIG. 8 shows the RFID marking of a cylinder-shaped vessel 1 whose cylinder-shaped main section 12 is shorter in the axis direction than the optimal length of the dipole antenna 122 for the transponder 2 in the desired frequency range. In this case, the dipole antenna 122 is disposed as an open coil around the cylinder-shaped main section 12 of the vessel 1. Here, according to the present invention, the coil axis is disposed parallel to the cylinder axis. To achieve as good a coupling of the antenna 122 to the electromagnetic field of the readout as possible, the dimension of the antenna in the direction of the cylinder axis—in other words the pitch of the open coil—is chosen to be as large as possible. In any case, the pitch of the coil is larger than the width of the circuit path of the antenna 122.

FIG. 8a shows a transponder 2 having a transponder chip 21, a dipole antenna 122 and connecting wires 23 on a flexible substrate 3 that is suitable for the RFID marking of the vessel 1 just described. In FIG. 8b is shown how the transponder 2 having substrate 3 is applied to the cylinder-shaped main section 12 of the vessel 1. FIG. 8c shows the finished, marked vessel 1 having transponder 2 and substrate 3.

While the invention has been shown and described with particular reference to preferred exemplary embodiments, it will be understood by the person skilled in the art that changes can be made in the form and details without departing from the spirit and scope of the invention. Accordingly, the disclosure of the present invention is not intended to be limiting. Instead, the disclosure of the present invention is intended to illustrate the scope of the invention as set forth in the following claims.

1-58. (canceled)

59. A system for marking, identifying and tracking substances or containers, comprising:
a plurality of homogeneous containers for transporting and storing substances,
which are each provided with a transponder for radio frequency identification, and
which in the system stand close together or touch each other,
wherein each of the homogeneous containers
exhibits a substantially cylinder-shaped main section having a curved lateral surface, and
the transponder includes an electronic memory and, as a coupling element, an antenna coil, wherein
the antenna coil is disposed in or on a wall surface of the container and with its axis parallel to the cylinder axis of the main section, and the antenna coil is disposed in the region of the cylinder-shaped main section of the container on the lateral surface of the cylinder and exhibits one or more windings around the cylinder axis,
further comprising for the transponders of the containers, one or more readout devices that are disposed at locations at which an identification or processing of the substances or containers is to take place, and past which the containers are directed with the same orientation of their cylinder axis.

60. The system according to claim 59, characterized in that the antenna coil of the containers is disposed in or on a wall surface of the container such that the cylinder axis of the main section passes through the area of the antenna coil (22).

61. The system according to claim 59, characterized in that the cylinder-shaped main section of the containers constitutes a receiving region that receives the substances to be transported or stored.

62. The system according to claim 59, characterized in that the cylinder-shaped main section of the containers is connected with a conically tapering receiving region that receives the substances to be transported or stored.

63. The system according to claim 59, characterized in that the cylinder-shaped main section of the containers constitutes a handling region that serves the handling, such as the transportation or storage, of the container.

64. The system according to claim 59, characterized in that the cylinder-shaped main section of the containers exhibits no edges.

65. The system according to claim 59, characterized in that the cylinder-shaped main section of the containers takes up more than 50%, especially more than 70% of the dimension of the container in the direction of the cylinder axis.

66. The system according to claim 59, characterized in that the containers consist of a plastic material such as PE, PP, PS, PET, ABS, an epoxide resin, a molding compound or IC sealing compound, or of glass.

67. The system according to claim 59, characterized in that the transponder of the containers is embedded under the surface of the container in plastic, glass or a lacquer layer.

68. The system according to claim 59, characterized in that the transponder of the containers is disposed in the base or lid of the containers.

69. The system according to claim 68, characterized in that the transponder is attached in a sealed disk at the base or lid of the containers.

70. The system according to claim 68, characterized in that the transponder is attached at the base or lid by gluing, by melting when manufacturing the containers or as an insert in injection molding.

71. The system according to claim 59, characterized in that the containers are (returnable) bottles, recycling containers or cups manufactured in the deep drawing method.

72. The system according to claim 59, characterized in that the containers are reaction vessels, such as a sample tube, an Eppendorf tube or a Petri dish, especially for clinical and biochemical labs, or sample vessels within a microtiter plate.

73. The system according to claim 59, characterized in that the electronic memory of the containers contains data, such as an identification number, specification of the contents, origin of the contents, patient data for clinical applications, processing steps performed or to be performed, processing stations passed through or to be passed through, staging points and times, physical measurands, such as temperature, pressure, fill level and acceleration, that stem especially from a sensor integrated into the transponder, manufacturing date of the contents and/or of the containers, and operating manual or control code for processing systems.

74. The system according to claim 59, characterized in that the containers comprise a rotation limiter that, on a conveyance path, prevents the rotation of the containers about their own axis.

75. The system according to claim 59, characterized in that the containers comprise a spacer that ensures a preselected minimum spacing of adjacent containers on a conveyance path.

76. A container for transporting and storing substances that is provided with a transponder for radio frequency identification, wherein
the container exhibits a substantially cylinder-shaped main section (12) having a curved lateral surface, and
the transponder includes an electronic memory (21) and, as a coupling element, a dipole antenna (122) that is disposed in the region of the cylinder-shaped main section (12) of the container in or on the lateral surface of the cylinder, and wherein
the dipole antenna (122) is wound around the cylinder-shaped main section (12) of the container as an open coil with the coil axis parallel to the cylinder axis of the main section (12).

77. The container according to claim 76, characterized in that the dipole antenna (122) is wound around the cylinder-shaped main section (12) of the container as an open coil with such a pitch that the dipole antenna (122) extends parallel to the cylinder axis substantially across the entire dimension of the main section.

78. The container according to claim 76, characterized in that the cylinder-shaped main section (12) constitutes a handling region that serves the handling, such as the transportation or storage, of the container.

79. The container according to claim 76, characterized in that the transponder (21, 22) is embedded under the surface of the container in plastic, glass or a lacquer layer.

80. The container according to claim 76, characterized in that the transponder (21, 22) is disposed in the base (11) or lid of the container (1).

81. The container according to claim 80, characterized in that the transponder is attached in a sealed disk (2) at the base (11) or lid of the container (1).

82. The container according to claim 80, characterized in that the transponder is attached at the base (11) or lid by gluing, by melting when manufacturing the container (1) or as an insert in injection molding.

83. The container according to claim 76, characterized in that the container (1) is a (returnable) bottle, a recycling container or a cup manufactured in the deep drawing method.

84. The container according to claim 76, characterized in that the container (1) is a reaction vessel, such as a sample tube, an Eppendorf tube or a Petri dish, especially for clinical and biochemical labs, or a sample vessel within a microtiter plate.

85. The container according to claim 76, characterized in that the electronic memory (21) contains data, such as an identification number, specification of the contents, origin of the contents, patient data for clinical applications, processing steps performed or to be performed, processing stations passed through or to be passed through, staging points and times, physical measurands, such as temperature, pressure, fill level and acceleration, that stem especially from a sensor integrated into the transponder, manufacturing date of the contents and/or of the container, and operating manual or control code for processing systems.

86. The container according to claim 76, characterized in that the container comprises a rotation limiter that, on a conveyance path, prevents the rotation of the container about its own axis.

87. The container according to claim 76, characterized in that the container comprises a spacer that ensures a preselected minimum spacing of adjacent containers on a conveyance path.

88. A method for automatically marking, identifying and tracking substances or containers, having the following method steps:
providing a system in which homogeneous containers stand close together or touch each other according to claim 59,
writing an unambiguous identification code to the electronic memory of the transponder of the containers,
filling the substances into the containers, and
reading out the identification code when a container is located at one of the readout devices.

89. The method according to claim 88, characterized in that information about the substance to be filled or the filled substance is written to the electronic memory.

90. The method according to claim 88, characterized in that, when the container is located at one of the readout devices, a time code, location code and/or data pertaining to the substance processing is written to the electronic memory.

91. The method according to claim 88, characterized in that a plurality of homogeneous containers is labeled and filled with substances, and all containers are directed past the readout device(s) with the same orientation of their cylinder axis.

92. A method for automatically marking, identifying and tracking a substance, having the following method steps:
providing a container according to claim 76,
providing for the transponder one or more readout devices that are disposed at locations at which an identification or processing of the substance is to take place,
writing an unambiguous identification code to the electronic memory of the transponder,
filling the substance into the container, and
reading out the identification code when the container is located at one of the readout devices.

93. The method according to claim 92, characterized in that information about the substance to be filled or the filled substance is written to the electronic memory.

94. The method according to claim 92, characterized in that, when the container is located at one of the readout devices, a time code, location code and/or data pertaining to the substance processing is written to the electronic memory.

95. The method according to claim 92, characterized in that a plurality of homogeneous containers is labeled and filled with substances, and all containers are directed past the readout device(s) with the same orientation of their cylinder axis.
